(19) United States
(12) Patent Application Publication
(10) Pub. No.: US 2017/0024746 A1
(43) Pub. Date: Jan. 26, 2017

(54) Process to Enable Digital Registration, Compliance Enforcement, and Permission Indications for Unmanned Aerial Vehicles and Other Devices

(71) Applicants: Donald Putnam Henry, Menlo Park, CA (US); Charles Marshall, Atherton, CA (US)

(72) Inventors: Donald Putnam Henry, Menlo Park, CA (US); Charles Marshall, Atherton, CA (US)

(73) Assignee: AerWaze, East Palo Alto, CA (US)

(21) Appl. No.: 15/095,038

(22) Filed: Apr. 9, 2016

Related U.S. Application Data
(60) Provisional application No. 62/145,577, filed on Apr. 10, 2015.

(51) Int. Cl. G06Q 30/00; H04W 4/02; B64C 39/02; H04W 4/00

(52) U.S. Cl. CPC G06Q 30/018; H04W 4/003; H04W 4/026; B64C 39/024; H04W 88/02

(57) ABSTRACT

This application discloses a system which allow registrations or licenses for multiple jurisdictions to be electronically maintained on a mobile device or central server which are tied to an application running on a mobile device. The application running on the device may have several modes. Administrative mode allows for login and other administrative functions. Inquiry mode allows an operator to determine if he or she has necessary registrations, permits, licenses, or insurance coverage for the current location. Flight mode transmits location and identity to a central server at regular intervals which can be made available to local authorities or others. Verification mode allows an operator to provide proof of registrations, permits, or licenses to authorities. Purchase mode allows an operator to immediately and remotely obtain any needed but missing registration, permit, license or insurance coverage. This process allows certificates from multiple jurisdictions or subdivisions within jurisdictions which may have reciprocity arrangements to be readily accessible from a mobile device. The process allows operators to determine if their “paperwork” is in order to fly from a given location (and perhaps time). It can alert authorities when an operator is flying without proper “paperwork.” It can also help identify the operator of a UAV in a given area or provide insight into the UAVs flying in an area.

### CROSS REFERENCE TO RELATED APPLICATIONS

The present application relates to and claims priority of U.S. provisional patent application (“Copending Provisional Application”), Ser. No. 62/145,577, entitled “A PROCESS TO ENABLE DIGITAL REGISTRATION, COMPLIANCE ENFORCEMENT, AND PERMISSION INDICATIONS FOR UNMANNED AERIAL VEHICLES AND OTHER DEVICES,” filed on Apr. 10, 2015. The disclosure of the Copending Provisional Application is hereby incorporated by reference in its entirety.

### BACKGROUND OF THE INVENTION

1. Field of Invention

The FAA has only recently implemented a national registration process for unmanned aerial vehicles (UAVs). Some municipalities such as Costa Mesa, Calif. have long ago implemented their own permitting policies. With the burgeoning numbers of UAVs, more and more jurisdictions are interested in implementing permitting, registration, licensing, or insurance requirements for UAVs or their operators.

2.Discussion of the Related Art

While the Federal Aviation Administration has long had a system registering manned aircraft and licensing their pilots, it only recently implemented a national system of registering unmanned aircraft. To date, there is no requirement for licensing their operators. Nor is there any statewide system in any state for registering unmanned aircraft or licensing their operator such as is seen with ground-based motor vehicles. A number of municipalities already implemented such programs as registration and licensing may be required to operate in a given municipality, and there may be reciprocal arrangements between and among municipalities to honor each other's registrations and licenses. Requirements for UAV insurance coverage are likely to emerge in the next few years.

### SUMMARY OF THE INVENTION

This application discloses a series of related processes which allow registrations, permits, licenses, and insurance coverage for multiple jurisdictions to be digitally maintained on a mobile device or central server which are tied to an application running on a mobile device. If the registrations, licenses, permits, and insurance coverage (hereinafter called collectively “certificates”) reside on a mobile device, the application, when activated, provides those certificates to a central server. Alternatively, if the certificates are resident on a central server, the operator can log in to the central server using a unique username and password through the application running on the mobile device, and the server will link those certificates to the instance of the application running on that particular device. The application can be run in several modes:
a) In the administrative mode, the operator/user can log in and link to the central server or perform other administrative functions.
b) In inquiry mode, the application will send the location of the device (based on Global Positioning System (GPS) or other means) to the server which will determine whether the operator and his or her UAVs have the required registrations, licenses, permits, and insurance coverage to operate at that location and time (and may also provide warnings about other restrictions on flying UAVs at or near the location of the operator).
c) In the flight mode, the application periodically (perhaps every minute or some other interval) sends a signal to the central server which links that location to the certificates tied to the mobile device, the certificates tied to the account signed into on the central server through the mobile device, or other identity or identifying information linked to the account or mobile device not linked to certificates. In the flight mode, the location of the operator's mobile device and additional information such as operator identity, UAV identification, and certificate status will be provided to authorities in which the operator is located (and perhaps others for safety of flight, transparency, or UAV activity awareness). If such data can be made available on the mobile device or if the mobile device (or another linked device) resides on the UAV rather than with the operator, the location of the UAV rather than the operator can be provided.
d) In verification mode, the application can verify to authorities that an operator has the required certificates to operate in a given location.
e) In purchase mode, the application can be used to obtain certificate needed for a given location (current location or other) which the operator or UAV does not currently possess.

This process allows certificates from multiple jurisdictions or subdivisions within jurisdictions which may have reciprocity arrangements to be readily accessible from a mobile device. The process allows operators to determine if their “paperwork” is in order to fly from a given location. It can alert authorities when an operator is flying without proper “paperwork.” It provides a one-stop portal for operators to obtain certificates needed to fly in an area. It can also help identify the operator of a UAV in a given area or provide insight into the UAVs flying in an area.

### BRIEF DESCRIPTION OF THE DRAWINGS

FIG. 1 shows multiple digital certificates linked to a particular mobile device.

FIG. 2 shows an illustrative map of various certificate requirements.

FIG. 3 shows the communications architecture of this process.

FIG. 4 shows various states possible in inquiry mode.

FIG. 5 shows various uses of information generated in flight mode.

FIG. 6 shows an illustrative verification mode.

FIG. 7 shows an illustrative purchase mode.

### DETAILED DESCRIPTION OF THE PREFERRED EMBODIMENTS

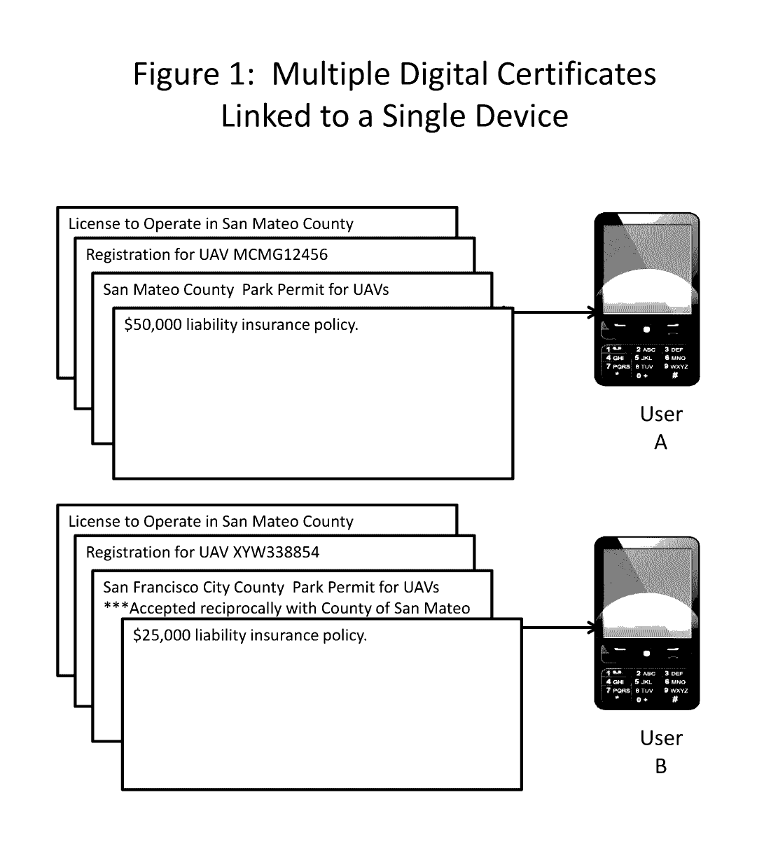

This disclosure describes a series of related processes that can be used to create a digitally available registration, licensing, and permitting system across multiple jurisdictions for unmanned aerial vehicles which may also be used for other devices. A municipality, state, the federal government, or other jurisdiction may impose registration requirements on UAV airframes, demand licensing for operators, require permits (especially for commercial use), or mandate insurance to fly in certain jurisdictions. Collectively, these will be called certificates here. An operator may have a number of certificates which allow UAV flights in certain areas (and perhaps times). A digital version of these certificates can be stored on a mobile device or on a central server. An application running on a mobile device either provides relevant certificates to a central server or the operator has an account on the central server which is accessible through the mobile device application by entering a user name and password (or some other means of verification). See FIG. 1.

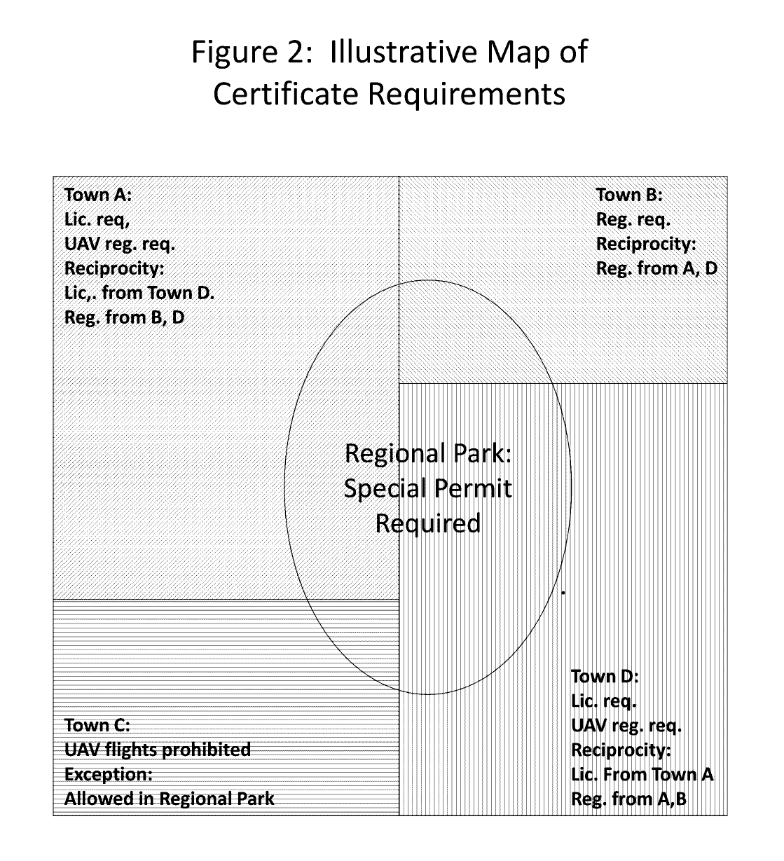

The requirements for and validity of any certificate will be location dependent. For example, is the operator within the certificate issuing jurisdiction or a jurisdiction with a reciprocity arrangement with the issuing authority? There also may be a time component for certain certificates. See FIG. 2 for an illustrative example of geographically required certificates.

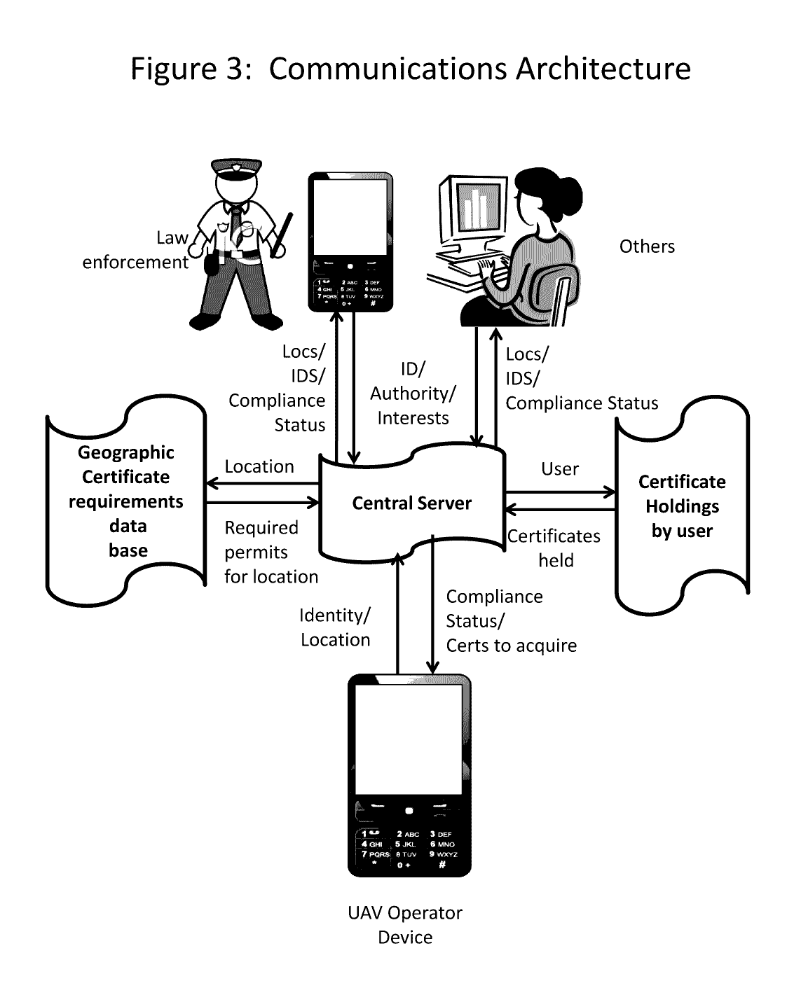

The related processes in this disclosure link a) an application running on a mobile device which a UAV operator has in his or her possession, b) a database of certificates, c) a geographical database of certificate requirements, and a central service linking a-c and providing results of information derived from this linkage to the operator through the application, to relevant authorities, and to others with a stake or interest in obtaining information about UAV operations. See FIG. 3.

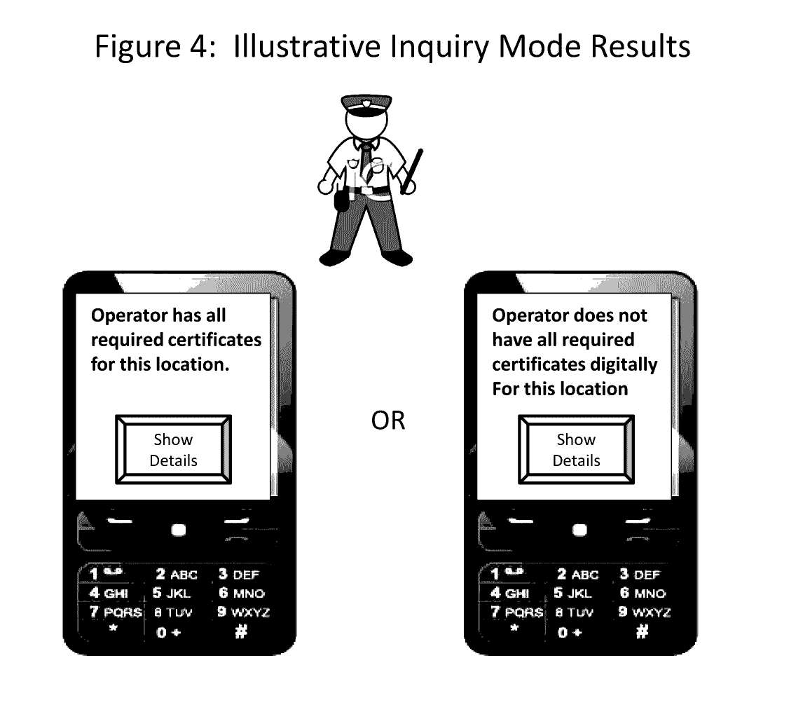

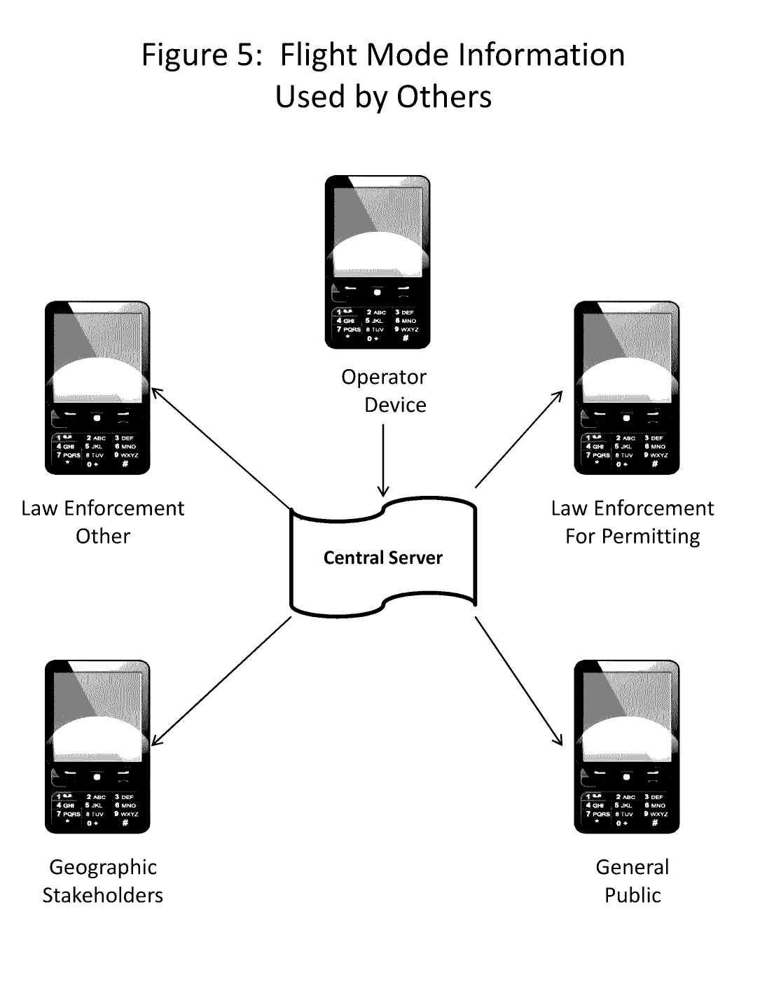

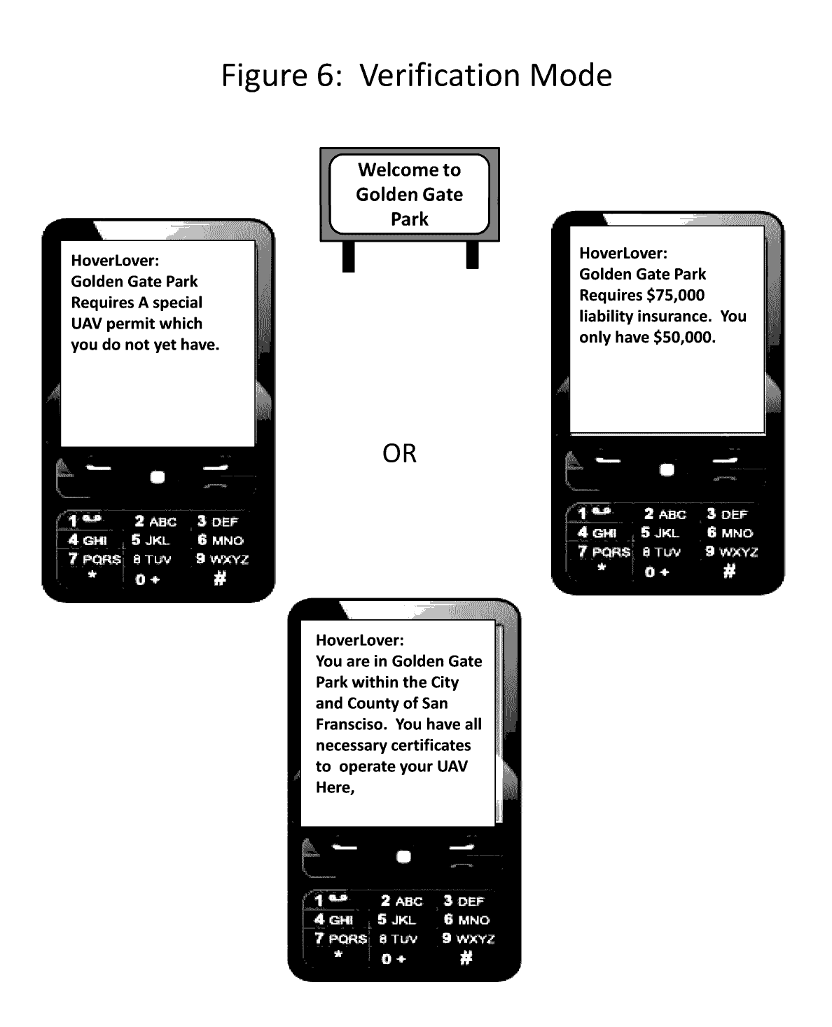

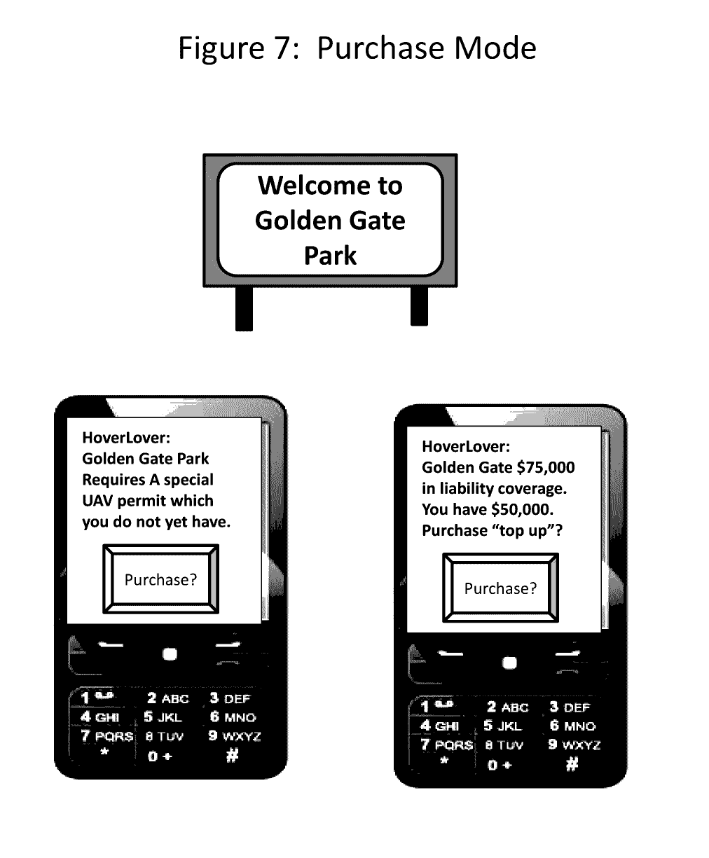

The application running on the mobile device may have a number of modes. These include:
a) In the administrative mode, the operator/user can log in and link to the central server or perform other administrative functions.
b) In inquiry mode, the application will send the location of the device (based on Global Positioning System (GPS) or other means) to the server which will determine whether the operator and his or her UAVs have the required registrations and licenses to operate at that location and time (and may also provide warnings about other restrictions on flying UAVs at or near the location of the operator). See FIG. 4.
c) In the flight mode, the application periodically (perhaps every minute or some other interval) sends a signal to the central server which links that location to the certificates tied to the mobile device, the certificates tied to the account signed into on the central server through the mobile device, or other identity or identifying information linked to the account or mobile device not linked to certificates (perhaps from a voluntary registration program). In the flight mode, the location of the operator's mobile device and additional information such as operator identity, UAV identification, and permit status will be provided to authorities in which the operator is located (and perhaps others for safety of flight, transparency, or UAV activity awareness). If such data can be made available on the mobile device or if the mobile device (or another linked device) resides on the UAV rather than with the operator, the location of the UAV rather than the operator can be provided. See FIG. 5.
d) In verification mode, the application can verify to authorities that an operator has the required certificates to operate in a given location. See FIG. 6.
e) In purchase mode, the application can be used to obtain certificate needed for a given location (current location or other) which the operator or UAV does not currently possess. See FIG. 7. This could be a registration, license, permit, or insurance coverage. The insurance coverage could be for new policy, a temporary or permanent increase on an existing policy, or a “top up” policy which brings total coverage to required level (temporary or permanent).

The disclosed processes allow certificates from multiple jurisdictions or subdivisions within jurisdictions which may have reciprocity arrangements to be readily accessible from a mobile device. The process allows operators to determine if their “paperwork” is in order to fly from a given location. It can alert authorities when an operator is flying without proper “paperwork.” It provides a one-stop portal for operators to obtain certificates needed to fly in an area. It can also help identify the operator of a UAV in a given area or provide insight into the UAVs flying in an area.

While the processes described here was developed to facilitate regulation of UAVs, the processes can also be used for any mobile, regulated activity.

What is claimed is:

1. A process whereby registrations for UAVs (or other devices), licenses for UAV operators (or other devices), permits for operating UAVs (or other devices), and insurance coverage in certain places or at certain times which may be from numerous jurisdictions are maintained digitally on a mobile device or central server and the mobile device communicates with the central server through an application running on the mobile device.

2. A further embodiment of claim 1 in which the location of the operator of the UAV (or other device) is determined by the mobile device through the Global Positioning System or other location determining technology is transmitted to the central server which determines whether the operator has all necessary registrations, licenses, permits, and insurance coverage for that location and transmits that information to the application on the mobile device.

3. A further embodiment of claim 1 in which the operator activates a flight (or other activity) notification part of the application on the mobile device when he or she is operating a UAV (or other device) and that information is transmitted at regular intervals to the central server and made available to others.

4. A specific embodiment of claim 3 in which enforcement authorities for UAV (or other device) operations in a location are notified of the location, identity, and other information about an operator has invoked the flight (or other activity) notification mode on a mobile device from a location where that operator lacks the necessary registrations, licenses, permits, or insurance coverage to fly a UAV (or operate another device).

5. A specific embodiment of claim 3 in which information, which may include location of the operator, identity of the operator, identification of the UAV (or other device) are made available to public or privates which have a stake in or interest about UAV operations (or operations of other devices) in an area.

6. A specific embodiment of claim 5 in which such information is provided to law enforcement about UAVs (or other devices) operating nearby for enforcement of registration, licensing, permitting, insurance coverage or other laws and regulations (such as unsafe flight or flying in a restricted or prohibited area).

7. A specific embodiment of claim 5 in which such information is provided to the public through any means but including an application on a mobile device which discloses some information about UAV flights (or other device operations) near the current location of the device or other specific location.

8. A further embodiment of claim 1 in which the UAV (or other device operator) can display through the application on his or her mobile device for verification purposes to law enforcement or others the registrations, licenses, permits, and insurance coverage held in digital form or a summary of such which shows whether or not all necessary registrations, licenses, and permits are held by the operator.

9. A further embodiment of claim 1 in which the operator of a UAV (or other devices) can remotely obtain (including paying any required fees or premiums) through the application on the operator's mobile device any registrations, licenses, or certificates, permits, or insurance coverage for a specific location including but not limited to the current location of that device.

10. A variation of claim 9 in which a web portal which might but does not need to be accessed through a mobile device in which an operator of UAVs (or other devices) can determine what registrations, licenses, and permits, certificates, or insurance coverage are necessary for a given location and through which the operator can remotely obtain such and which then might be made available through a mobile device application.

11. A specific embodiment of claim 1 in which such registrations, licenses, permits, and insurance coverage for UAVs in certain places or at certain times which may be from numerous jurisdictions are maintained digitally on a mobile device or central server and the mobile device communicates with the central server through an application running on the mobile device.

12. A further embodiment of claim 11 in which the location of the operator of the UAV is determined by the mobile device through the Global Positioning System or other location determining technology is transmitted to the central server which determines whether the operator has all necessary registrations, licenses, permits, and insurance coverage for that location and transmits that information to the application on the mobile device.

13. A further embodiment of claim 11 in which the operator activates a flight notification part of the application on the mobile device when he or she is operating a UAV and that information is transmitted at regular intervals to the central server and made available to others.

14. A specific embodiment of claim 13 in which enforcement authorities for UAV operations in a location are notified of the location, identity, and other information about an operator has invoked the flight notification mode on a mobile device from a location where that operator lacks the necessary registrations, licenses, permits, or insurance coverage to fly a UAV.

15. A specific embodiment of claim 13 in which information, which may include location of the operator, identity of the operator, identification of the UAV are made available to public or privates which have a stake in or interest about UAV operations in an area.

16. A specific embodiment of claim 15 in which such information is provided to law enforcement about UAVs operating nearby for enforcement of registration, licensing, permitting, insurance coverage or other laws and regulations (such as unsafe flight or flying in a restricted or prohibited area).

17. A specific embodiment of claim 15 in which such information is provided to the public through any means but including an application on a mobile device which discloses some information about UAV flights near the current location of the device or other specific location.

18. A further embodiment of claim 11 in which the UAV can display through the application on his or her mobile device for verification purposes to law enforcement or others the registrations, licenses, permits, and insurance coverage held in digital form or a summary of such which shows whether or not all necessary registrations, licenses, and permits are held by the operator.

19. A further embodiment of claim 11 in which the operator of a UAV can remotely obtain (including paying any required fees or premiums) through the application on the operator's mobile device any registrations, licenses, or certificates, permits, or insurance coverage for a specific location including but not limited to the current location of that device.

20. A variation of claim 19 in which a web portal which might but does not need to be accessed through a mobile device in which an operator of UAVs can determine what registrations, licenses, and permits, certificates, or insurance coverage are necessary for a given location and through which the operator can remotely obtain such and which then might be made available through a mobile device application.
